(19) United States
(12) Patent Application Publication
(10) Pub. No.: US 2006/0204948 A1
(43) Pub. Date: Sep. 14, 2006

(54) Method of training and rewarding employees

(76) Inventor: William Sims, JR., Chopin, SC (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/340,205

(22) Filed: Jan. 26, 2006

Related U.S. Application Data
(60) Provisional application No. 60/660,300, filed on Mar. 10, 2005.

(51) Int. Cl. G09B 7/00

(52) U.S. Cl. 434/323

(57) ABSTRACT

A system and method of training and rewarding an employee is disclosed. The system includes a console, including a computer system; a software program, installed on the computer system for training and testing the employee; an input device, mounted on the console, and operatively connected to the computer system in the console; and a printer, mounted within the console, operatively connected to the computer system in the console to print a reward for the employee. The method includes the steps of providing the console at an industrial facility; training the employee using the software program; testing the employee at the console; and generating a reward for the employee after the employee successfully tests.

### CROSS REFERENCED TO RELATED APPLICATIONS

This application claims the benefit of U.S. Provisional Patent Application Ser. No. 60/660,300, filed on Mar. 10, 2005, which is incorporated herein in its entirety.

### FIELD OF THE INVENTION

The present invention relates to a method of training and rewarding employees, and in particular to a method of training and rewarding employees using a kiosk placed in a plant/industrial environment.

### BACKGROUND OF THE INVENTION

In today's age of quality management, training, and certification of employees, employers are in need of novel methods of training their employees and inspiring in the employees a desire to train and become certified. In many cases, employers will offer a reward to an employee who gets trained and/or certified. In order to provide this training, employers must often hire consultants and hold courses for numerous employees at a time, which takes that number of employees out of production in order to train them. Additionally, it can be costly to pay a consultant to train and certify employees. A number of methods of training employees have been introduced to the market in order to attempt to solve this problem.

U.S. Pat. No. 6,589,055 discloses a system and method for computer aided training and certification that employs a central network for storing certification information and a plurality of training units. In preferred embodiments, the training units are individual systems comprising training software running on a turn-key based personal computer. An advantage of the invention is that the software is completely customized on each training unit to provide instruction using customized multi-media content, such as high quality digital video footage, taken of the trainee's specific job tasks and work site, as well as questions and instructional scripts customized for the job tasks and work site.

U.S. Pat. No. 6,157,808 discloses a computer system and a method for a computer-based data integration and management processing system and a method to support an efficient management of employee development, training and performance improvement in a performance-competence based organization. The present invention includes an integrated system that provides an ability to develop training material, career paths or to determine an employee's qualifications and performance. The present invention provides comprehensive support for job and task analysis; learning objective development; standards and processes; objective, reference based test items; examination and evaluations; training program identification and content description; training scheduling; training-evaluation documentation; and reporting. Each job defined in the current system has specific duties, tasks and skills associated with an identified job. Because the specific skills can be represented by accepted standards of certification; the system is able to establish an association between the certifications and employees responsibilities. This association permits the system to instantly identify the level of qualification of any employee and verify that the employee is qualified to perform the duties assigned.

U.S. Pat. No. 6,514,079 discloses a system and method of interactive multimedia teaching and learning, through the use of audiovisual presentations. The invention provides a computer based multimedia presentation which may include pictures, sound, graphics and text to provide a trainee with a presentation regarding the performance of an occupational skill.

U.S. Pat. No. 6,377,781 discloses a system that provides a session for a quiz on a computer system. The system operates by receiving a request to create a session for the quiz. In response to the request, the system creates the session. This session provides a mechanism through which a selected group of people can take the quiz. The system also associates the session with an owner of the session in order to facilitate channeling results generated by the selected group of people in taking the quiz to the owner of the session. Next, the system makes the session for the quiz available over a network so that the selected group of people can take the quiz from remote nodes on the network. Upon receiving the results from the selected group of people taking the quiz, the system communicates the results to the owner of the session. In one embodiment of the present invention, the owner of the session for the quiz is an educator, and the selected group of people are students of the educator.

U.S. Pat. No. 6,537,072 discloses a system and method for educating an individual with the skills necessary to perform a new job, as well as providing the individual with practical work experience by providing the individual with work to perform, where the work is capable of being performed by someone having the individual's skill level.

U.S. Pat. No. 6,546,230 discloses a technique for testing and training health care professionals. Competency tests are stored on machine readable media and transmitted via network connections to remote provider systems, such as workstations or diagnostic systems. A health care professional can take a competency test on a particular topic and input his/her responses at the remote provider system. The health care professional's responses are evaluated, and an assessment of his/her skills displayed at the provider system. The assessment particularly points out those areas, if any, where the health care professional's knowledge is deficient. If the health care professional has any areas which need improvement, a list of relevant courses is also displayed at the provider system. The health care professional may then select a desired course from the user interface. The machine readable media maintains a record of the health care professional's assessment as well as a list of completed courses. This information may then be provided to a licensing entity for credit.

U.S. Pat. No. 5,779,486 discloses an educational method and system that assesses and enhance a student's understanding in a subject. Based on the student's understanding, individually-tailored tests are generated, whose difficulties are geared towards the student's level of understanding in the subject. Thus, the student not only can use the tests to prepare for an examination, but can also use the tests to learn the subject. The system includes a score generator coupled to a recommendation generator. In one preferred embodiment, the recommendation generator includes an inference engine, and in another preferred embodiment, the recommendation generator includes a pre-requisite analyzer. Both the pre-requisite analyzer and the inference engine in the recommendation generator can generate recommendations based on the student's test results. The recommendation generator is coupled to a report generator and a question generator. The report generator accesses a report format. Based on the recommendations and the report format, the report generator generates a report, which can provide assessment of the student's understanding in different areas of the subject, and which can provide action items to improve on the student's understanding in the subject. The question generator, based on the recommendations, generates a number of questions. The student can take this new set of questions to further enhance her understanding in the subject.

U.S. Pat. No. 5,306,154 is directed to an intelligent education and simulation system which is capable of executing an optimized follow-up reeducation to the learner reflecting his/her idiosyncrasy toward understanding in learning. The intelligent education and simulation system has an execution instruction to execute a curriculum comprising a plurality of instruction courses regarding the subject teaching of an educational object and its simulation-based instruction. According to this execution instruction, intelligent computer assisted instruction of the subject teaching and the simulation-based instruction are implemented. The degree of understanding of these instructions by the learner is evaluated, and according to the degree of understanding thus comprehended, a pertinent follow-up instruction course(s) is chosen for reeducation. In this way, a pertinent reeducation instruction course(s) optimized for each learner is capable of being selected, and the time required for reeducation of the learner is minimized.

There is a need, however, for a system and method of training and certifying employees which also inherently rewards them on the spot. None of the above disclosure provide a system and method which accomplishes this. It would therefore be beneficial if a system and method existed that would allow an employer to have an employee trained on the spot and to receive a reward after being trained and certified.

### OBJECTS AND SUMMARY OF THE INVENTION

It is an object of the present invention to provide a novel system to train and reward employees.

It is a further object of the present invention to provide a novel method for training and rewarding employees.

In accordance with a first aspect of the present invention, a novel system for training and rewarding employees is provided. The novel system includes a console, including a computer system; a software program, installed on the computer system for training and testing the employee; an input device, mounted on the console, and operatively connected to the computer system in the console; and a printer, mounted within the console, operatively connected to the computer system in the console to print a reward for the employee.

In accordance with a further aspect of the present invention, a novel method for training and rewarding employees is provided. The novel method includes the steps of providing the console at an industrial facility; training the employee using the software program; testing the employee at the console; and generating a reward for the employee after the employee successfully tests.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is schematic diagram of a training and rewarding system in accordance with the present invention.

FIG. 2 is a flow diagram of a method of training and rewarding an employee in accordance with the present invention.

### DETAILED DESCRIPTION OF THE PREFERRED EMBODIMENT

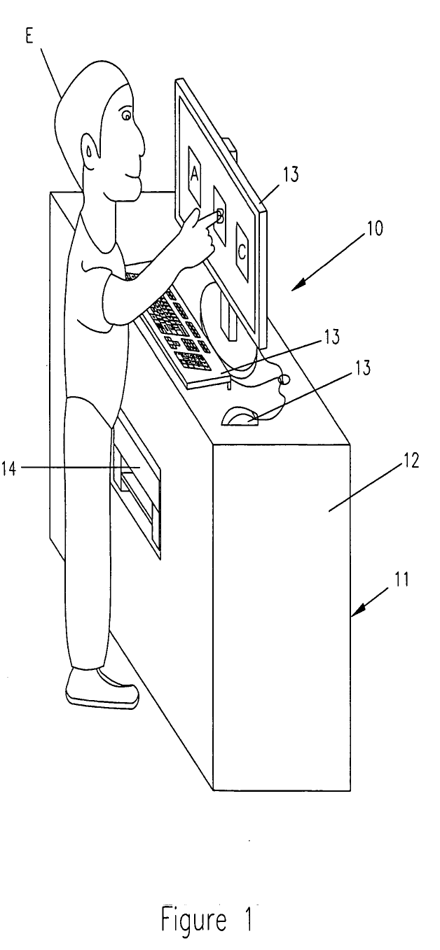

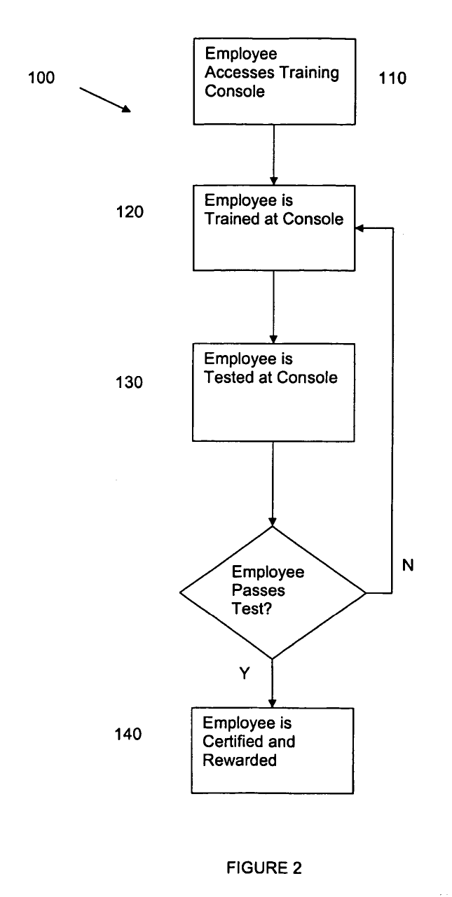

Referring now to the drawings, wherein like reference numerals refer to the same components across the several views and in particular to FIGS. 1 and 2, there is shown a system for training and rewarding employees 10. The system 10 includes a console 11 operated by an employee E.

The console 11 includes a computer system 12, an input device 13, and a printer 14. The computer system 12 is loaded with a software program that will allow the employee to be trained and tested on the console 11. The input device 13 allows the employee to interact with the computer system 12 of the console 11. The input device 13 in a preferred embodiment of the present invention is a touch screen, but can be any standard computer input device such as a mouse, keyboard, and the like. The printer 14 is operatively connected to the computer system 12 so that when directed by the software program, the printer 14 can print a reward token or ticket for the employee.

The console 11 can be placed in an industrial plant by an employer to train and certify employees, and to provide them with an on the spot reward or token/ticket for a reward.

Referring now to FIG. 2, a preferred method for training and rewarding an employee 100 will be described. The method begins when the employee approaches the console in step 110. The console will prompt the employee for an identification number, and when the employee enters the identification number, the software program will recognize him and provide him with training in step 120. In particular, the training could be safety training, process training, or other training as the employer may require. After the employee has been trained on the material, the computer system 12 will test the employee in step 130. If the employee passes the test, then the employee will be certified and rewarded in step 140. If the employee does not pass the testing in step 130, then the employee returns for more training at step 120. In a preferred embodiment of the present invention, the reward is in the form of a simulated on-screen scratchoff, which the employee could determine what reward the employee will receive. Depending on the company's performance in areas such as safety, quality, production, sales, and the like, the employee might earn any number of scratchoffs. The reward revealed by the on-screen scratchoff could be points toward a gift, a chance at a trip, or an instant prize redeemed onsite. Referring now to FIG. 1, the printer 14 prints out a token or a ticket which specifies the employees reward, and which the employee can redeem. The ticket or token can either be mailed in for the reward, or an order can be made online. Additionally, the reward could be a coupon with a code given to the employee by the employer that would allow the employee to log onto the console using the coupon code to receive another on-screen scratchoff. Another embodiment of the kiosk award could encompass the ability to create an email with a true/false question which leads the user to a web page showing they earn a scratchoff for a correct answer, then by clicking on it the user is told they earn points toward a gift; or an email sent to a person with a virtual scratchoff which when clicked appears to reveal a sum of points beneath it; a special kind of paper scratchoff which includes a true/false box and a question on the rear, if the question is answered correctly the scratchoff token is valid for some type of reward or gift.

The kiosk may also be used as an information center to allow employees to enter information about their personal health and behaviors, including walking, pedometer usage, workouts, calories, foods eaten, as well as current health statistics like blood pressure, etc. The kiosk will award employees with scratchoffs and points for doing this and for showing improvements. This will be available by kiosk and at home and employees will earn HealthPerks or Health points for entering their data into this system and receiving points therefrom good toward prizes.

To encourage education and training, a game show format may be included on the kiosk such as Wheel of Fortune, Jeopardy, to allow employees to demonstrate their knowledge of a subject and then win/earn points towards prizes.

In addition, the onsite reward kiosk may make use of the following components: The ability to email out a newsletter on safety or wellness to a person with a true/false question that will earn the person a virtual scratchoff as below. Virtual Scratchoffs will be a web page where the user clicks the scratchoff area to reveal a prize, which may include points to collect towards a gift or an actual gift, e.g. dvd player etc.

Further, the kiosk may be deployed to track a number of behaviors including health risk as follows: Employees will have a health screen/physical and be assigned a high, low, or medium at risk category to indicate their health. They will log to this site to view their health points and will earn additional points and or virtual scratchoffs for doing things like those included in bubba.xls that improve their health and reduce their health costs. These virtual scratchoffs and prizes will be weighted so that the recipient wins more prizes more often based on two factors: readiness to change behaviors (e.g. they are ready for a weight loss class) and/or their risk category.

Another feature of the present invention is that of a reward card, such as a You Did It Right! Card in the present invention, whereby a manager or employee receives a supply of reward cards monthly. Each card will include a place for the Manager/Observing employee to note information such as the following: the id number of employee observed, the id number of the manager who observed them/date observed, and check boxes for Behaviors, which may number 1 to 20.

So for instance an manager may observe an employee lifting with their legs not their back (that could be behavior 1) and greeting a customer by name when entering a store (that might be behavior 2) and the manager would check off the good behaviors and give the card to the employee.

The employee could enter the reward card info into the kiosk, a website, or a toll free phone-in hotline. The employee would enter his id number, manager's id number, and the behaviors observed.

The system would then randomly award the employee a Scratchoff or Gift item such as a catalog award, movie ticket, or meal. The system would screen out to limit the employee from fraudulently claiming more cards than received, and would prevent managers from rewarding the same employee more than one time per month. The system would provide a variable win algorithm to reward first time employees more often with gifts than repeat employee callers.

A Training Card could also be handed to the employee who would be able to call the answers into a toll free phone line and earn prizes and chances at trips. The number of calls and the answers to them would be reported back to the sponsoring company.

The system would provide a variable win algorithm to reward first time employees more often with gifts than repeat employee callers. A further advantage of the Kiosk & Virtual Email/Web Based Scratchoff can be employed in a novel way, such as an employer wishes to reward employees who show improvement in their health including blood pressure, cholesterol and other measurable health biometrics. Further, that the employer wishes to reward employees who stop smoking, lose weight, exercise more, and the like. The employer may wish to divide employees into HIGH RISK, MED RISK, and LOW RISK groups where high risk have the highest health cost but low risk are lowest. When an employee changes their behavior or health biometrics the employer wishes to reward the employees by using a third party firm to reward the high risk employees MORE than low risk for the same behavior (e.g. a low risk employee who loses 5 pounds would earn less than a HIGH RISK employee).

In another example, a scratchoff might reward a $100 gift to a HIGH RISK employee while a low risk employee gets only a $1 to $5 gift. The employer would also be able to stay compliant with the Health Insurance Portability and Accountability Act of 1996 (HIPAA) because the HIPM laws prevent the employer from knowing the health risk of the employee, and only the third party firm would know the status of the employee and reward them accordingly. Further, the invention provides administrative difficulty for the employer in determining the eventual value of the award given to the employee. This administrative difficulty also provides HIPAA protection.

Another embodiment is the use of a spyware/toolbar type program similar to the GATOR/GAIN software that will be installed on a person's internet browser. When the person visits certain websites a popup window will become visible and will flash to the person that they have won a prize. They will click it and see a virtual electronic scratchoff or a wheel of prizes which they can spin to earn gifts or chances at trips and other prizes. The software will record sites visited and actions taken and will drop earned points or credits into an account for that user which will be used to reward their participation.

Scratchoff tokens, whether online, virtual, or paper based can be allocated in such a way that the issuer cannot determine the value of the scratchoff allowing for favorable treatment for HIPAA and tax purposes

In view of the foregoing disclosure, some advantages of the present invention can be seen. For example, a novel system and method for training and rewarding employees is provided.

While the preferred embodiment of the present invention has been described and illustrated, modifications may be made by one of ordinary skill in the art without departing from the scope and spirit of the invention as defined in the appended claims. For example, other variations of the present invention can include the use of the kiosk for employee health and wellness. The kiosk can include the ability to email out a newsletter on safety or wellness to a person with a true/false question that will earn the person a virtual scratchoff as below. Virtual Scratchoffs will be a web page where the user clicks the scratchoff area to reveal a prize, the prize may be points to collect towards a gift or an actual gift, e.g. dvd player etc. Further, the kiosk can track a number of behaviors including health risk as follows: employees will have a health screen/physical and be assigned a high, low, or medium at risk category to indicate their health; they will log to this site to view their health points and will earn additional points and or virtual scratchoffs for doing things like those included in bubba.xls that improve their health and reduce their health costs. These virtual scratchoffs and prizes can be weighted so that the recipient wins more prizes more often based on two factors: readiness to change behaviors (e.g. they are ready for a weight loss class) and/or their risk category.

What is claimed is:

1. A system for training and rewarding an employee, comprising:
a console, including a computer system;
a software program, installed on the computer system for training and testing the employee;
an input device, mounted on the console, and operatively connected to the computer system in the console; and
a printer, mounted within the console, operatively connected to the computer system in the console to print a reward for the employee.

2. A method for training and rewarding an employee with a console including a computer system; a software program, installed on the computer system for training and testing the employee; an input device, mounted on the console, and operatively connected to the computer system in the console; and a printer, mounted within the console, operatively connected to the computer system in the console to print a reward for the employee, comprising the steps of:
providing the console at an industrial facility;
training the employee using the software program;
testing the employee at the console; and
generating a reward for the employee after the employee successfully tests.
